(19) United States
(12) Patent Application Publication
(10) Pub. No.: US 2015/0363148 A1
(43) Pub. Date: Dec. 17, 2015

(54) INFORMATION PROCESSING APPARATUS AND CONTROL METHOD, AND STORAGE MEDIUM

(71) Applicant: CANON KABUSHIKI KAISHA, Tokyo (JP)

(72) Inventor: Hiroshi Omura, Kawasaki-shi (JP)

(21) Appl. No.: 14/761,505

(22) PCT Filed: Jan. 8, 2014
(86) PCT No.: PCT/JP2014/000042

§ 371 Date: Jul. 16, 2015

(30) Foreign Application Priority Data
Jan. 21, 2013 (JP) 2013-008620

(51) Int. Cl. G06F 3/12

(52) U.S. Cl. CPC G06F 3/1256; G06F 3/1204; G06F 3/1224; G06F 3/1285; G06F 3/1292; G06F 3/1215; G06F 3/1276

(57) ABSTRACT

In an information processing apparatus, in a case where a printing instruction is output for generating print data via a printing dialog of an application in a first user interface environment and also a determination unit determines that a currently presented user interface environment is a second user interface environment, a display area where an instruction can be accepted is displayed in the second user interface environment, and when the display area is instructed, a printing-time input screen corresponding to the output instruction is displayed in the second user interface environment.

### TECHNICAL FIELD

The present invention relates to processing based on a print setting.

### BACKGROUND ART

Up to now, secure printing is proposed in which a printing apparatus executes printing based on print data while a user inputs an appropriate password to the printing apparatus. In a case where the secure printing is specified, a printer driver displays a printing-time input user interface (UI) for inputting a password. A value input to the printing-time input UI by the user (for example, a password) is then utilized, and the printer driver generates print data (PTL 1).

However, among operating systems (OSs), an OS that exclusively provides two UI environments also exists. As a result, according to PTL 1, an operability of the user may be degraded in a case where the printing-time input user interface is provided to an UI environment that is not intended by the user.

### CITATION LIST

### Patent Literature

### PTL 1: Japanese Patent Laid-Open No. 2001-318779

### SUMMARY OF INVENTION

### Solution to Problem

To solve the above-described problem, there is provided an information processing apparatus that can provide a first user interface environment and a second user interface environment, the information processing apparatus including: a determination unit configured to determine, in a case where an output instruction of a document is received in the first user interface environment, whether a currently presented user interface environment is the first user interface environment or the second user interface environment, in which when it is determined that the currently presented user interface environment is the second user interface environment, a printing-time input screen corresponding to the output instruction is displayed in the second user interface environment, and the printing-time input screen is displayed while a printing instruction for generating print data is input via a printing dialog of an application.

Further features of the present invention will become apparent from the following description of exemplary embodiments with reference to the attached drawings.

### BRIEF DESCRIPTION OF DRAWINGS

FIG. 1 illustrates a network configuration.

FIG. 2 illustrates a hardware configuration of a computer.

FIG. 3 illustrates a module configuration of software of the computer.

FIG. 4A is a schematic diagram of a screen of a desktop UI environment.

FIG. 4B is a schematic diagram of the screen of the desktop UI environment.

FIG. 4C is a schematic diagram of the screen of the desktop UI environment.

FIG. 4D is a schematic diagram of the screen of the desktop UI environment.

FIG. 4E is a schematic diagram of the screen of the desktop UI environment.

FIG. 5A is a schematic diagram of a screen of a touch panel UI environment.

FIG. 5B is a schematic diagram of the screen of the touch panel UI environment.

FIG. 5C is a schematic diagram of the screen of the touch panel UI environment.

FIG. 5D is a schematic diagram of the screen of the touch panel UI environment.

FIG. 5E is a schematic diagram of the screen of the touch panel UI environment.

FIG. 5F is a schematic diagram of the screen of the touch panel UI environment.

FIG. 5G is a schematic diagram of the screen of the touch panel UI environment.

FIG. 5H is a schematic diagram of the screen of the touch panel UI environment.

FIG. 6A is a sequence diagram between modules according to embodiments.

FIG. 6B is a sequence diagram between the modules according to the embodiments.

FIG. 6C is a sequence diagram between the modules according to the embodiments.

FIG. 6D is a sequence diagram between the modules according to the embodiments.

FIG. 6E is a sequence diagram between the modules according to the embodiments.

FIG. 7 is a flow chart according to a first embodiment.

FIG. 8 is a flow chart according to a second embodiment.

FIG. 9 is a flow chart of display processing of an input unit for a desktop UI according to the second embodiment.

FIG. 10 is a flow chart of display processing of an input for a touch panel UI according to the second embodiment.

FIG. 11 is a flow chart according to a third embodiment.

FIG. 12 is a flow chart according to a fourth embodiment.

FIG. 13 illustrates information supplied and received in a sequence according to the embodiments.

### DESCRIPTION OF EMBODIMENTS

### First Embodiment

For example, in a situation in which print setting information where information such as a password is to be input is set, a printing-time input screen (printing-time input UI) is displayed when a user inputs a printing instruction by using a client computer (information processing apparatus). On the other hand, among operating systems (OSs), an OS that exclusively provides two UI environments also exists. In a case where the OS exclusively provides the two UI environments, a printing-time input user interface for inputting information such as a password may be displayed in the UI environment that is not intended by the user. If the printing-time input user interface is displayed in the UI environment that is not intended by the user, the user switches the display to the UI environment where the printing-time input user interface is displayed. Thus, a problem exists that an operability of the user is degraded. Hereinafter, an operation for the user to instruct a printing execution by using a printing dialog provided by an application of the information processing apparatus may simply be described as printing instruction.

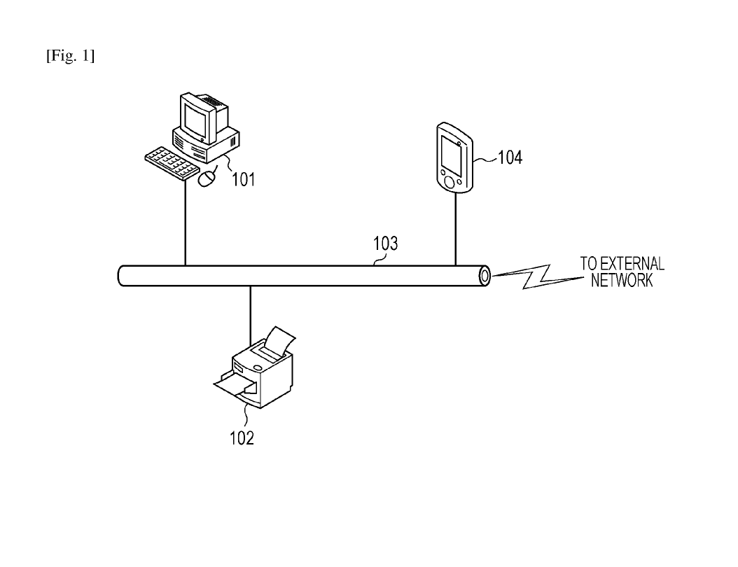

FIG. 1 is a block diagram of a schematic configuration of a system according to an embodiment of the present invention. This system includes a client computer 101 and a printer 102 that can receive data in a page description language (PDL) format and perform printing. The client computer 101 and the printer 102 are connected to each other via a network 103 represented by a local area network (LAN) so as to be communicable. The network 103 can be communicable with an external network. A portal device 104 illustrated in FIG. 1 may be connected to the network. The printer 102 may be composed of a single function printer provided only with a printing function or a multi function printer provided with the printing function, a scan function, and a copy function.

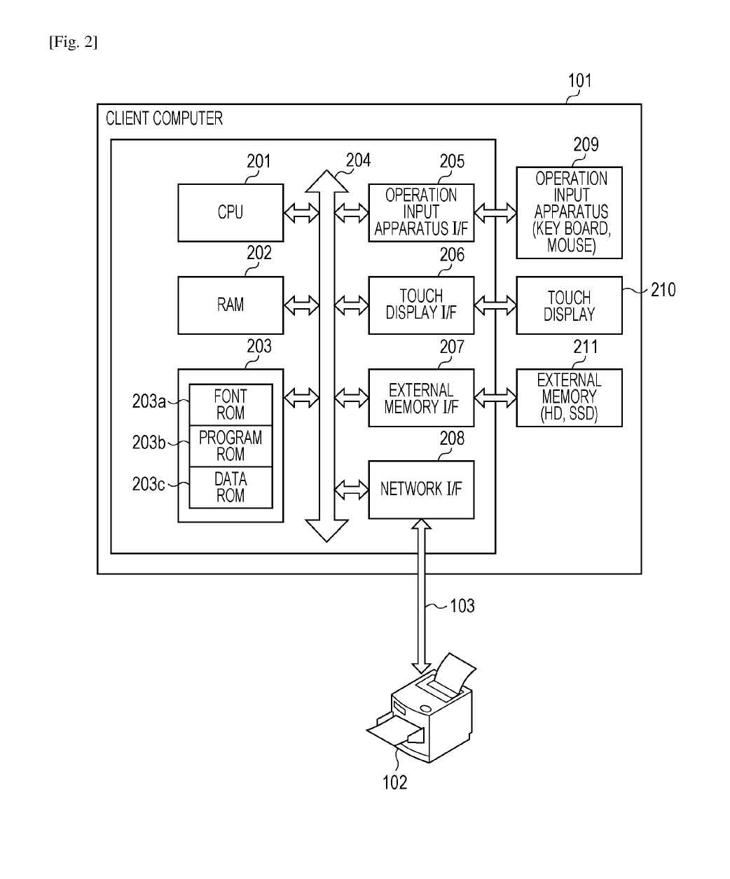

FIG. 2 is a block diagram of a hardware configuration of the client computer 101 of FIG. 1. In the client computer 101, a central processing unit (CPU) 201 controls respective devices connected to a system bus 204 while following a program stored in a random access memory (RAM) 202. The client computer 101 is provided with at least one CPU. The RAM 202 functions as a main memory, a work area, or the like of the CPU 201. A read only memory (ROM) 203 stores various programs and data. The RAM 202 is structured by being segmented into a font ROM 203a that stores various fonts, a boot program, a program ROM 203b that stores a basic input/output system (BIOS), and the like, and a data ROM 203c that stores various data. An operation input apparatus interface (I/F) 205 controls an operation input apparatus 209 such as a key board or a pointing device (mouse). A touch display I/F 206 controls a screen display to a touch display 210 and an input to the screen. In the present application, the description will be given by using the touch display 210, but the processing of the present application can also be realized by a display that does not correspond to a touch operation. An external memory I/F 207 controls an access to an external memory 211 such as, for example, a hard disk (HD) or a solid-state disk (SSD). The external memory 211 stores an operating system program (OS) as well as various applications, various files, and the like and functions as a computer-readable storage medium. The external memory 211 further stores an executable program related to the printing processing according to an embodiment of the present invention. A network I/F 208 is connected to the printer 102 via the network 103 and performs communication control processing with the printer 102.

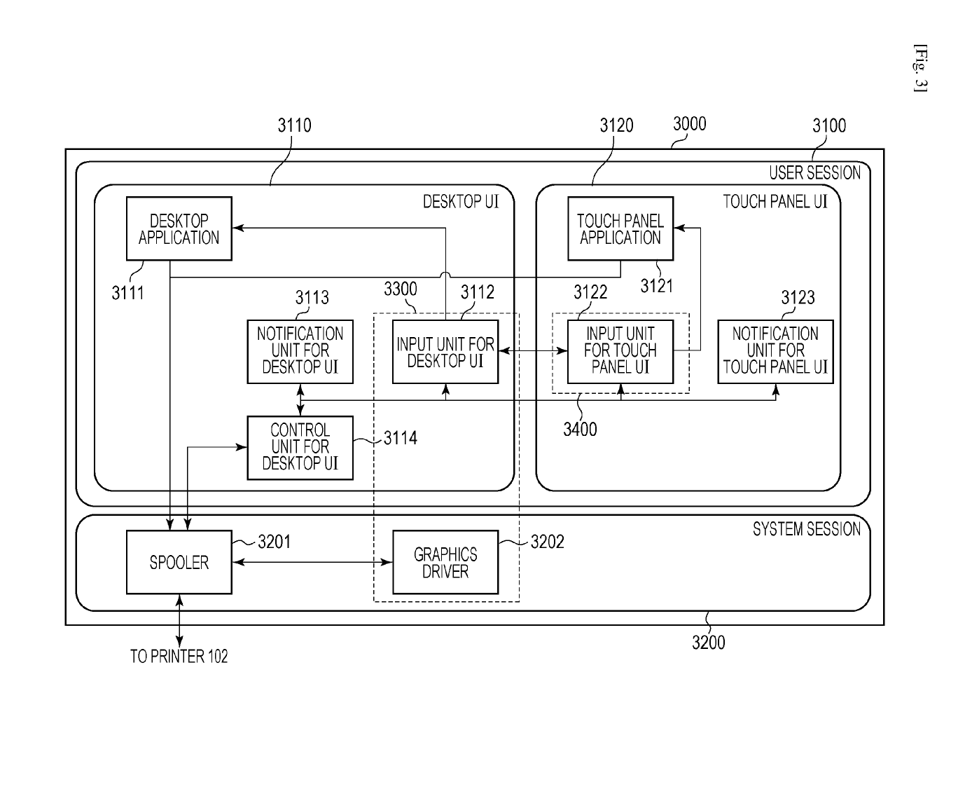

FIG. 3 is a block diagram of an OS 3000 that operates on the client computer 101. The respective modules of FIG. 3 are stored in the external memory 211. The module is appropriately loaded onto the RAM 202 and executed by the CPU 201 on the client computer 101.

To support login of plural users, a concept called session is introduced in the OS 3000. The session is a concept of a connection state such as a screen, a key board, and a process space prepared for each user.

Two types of sessions are proposed. One is a user session 3100 allocated to each user, and the other is a system session 3200 corresponding to a special session allocated to an operation of the OS. In general, the user session 3100 and the system session 3200 are separated from each other in consideration of security.

Information of each logged-in user is managed in the user session 3100. The user session 3100 is generated for each user when the user logs in the system and is ended when the user logs out.

When the user session 3100 is started, two user interface environments (UI environments) are generated. A desktop UI environment 3110 appropriate to an operation of the mouse and a touch panel UI environment 3120 appropriate to an operation of the touch panel are taken as examples of the two UI environments. The desktop UI environment 3110 is provided by a platform for the desktop UI environment, and the touch panel UI environment 3120 is provided by a platform for the touch panel UI environment. One screen of the screens of the two UI environments is exclusively displayed on the touch display 210, and the two screens are not displayed at the same time. In each of the UI environments, only an application of an architecture specific to the environment can be operated. Thus, a desktop application created for the desktop UI environment is not operated in the touch panel UI environment. The touch panel application created for the touch panel UI environment is not operated in the desktop UI environment. For that reason, in a case where an application of an UI environment different from the currently displayed UI environment is to be used, the user switches the UI environment for the operation.

In the desktop UI environment 3110, various desktop applications 3111 such as a document creation application and a WEB browser are installed and operated. In addition, for the print setting of the printer 102, an input unit 3112 for the desktop UI is installed. In addition, a printing-time input UI control unit 3114 is operated and controls on which of the UI environments an input screen at the time of the printing instruction (printing-time input UI) is displayed.

To provide a notification UI to the desktop UI environment 3110, a notification unit 3113 for the desktop UI is further prepared. In the touch panel UI environment 3120, various touch panel applications 3121 such as mail software and the WEB browser are operated. An input unit 3122 for the touch panel UI is also installed for the print setting of the printer 102. To provide a notification UI to the touch panel UI environment 3120, a notification unit 3123 for the touch panel UI is further prepared. The notification UI for the desktop UI, the notification UI for the touch panel UI, and the printing-time input UI control unit 3114 are described as the modules provided by the OS.

The system session 3200 is a session of the system that does not rely on the user. The system session 3200 is generated at the time of the activation of the OS 3000 and ended when the OS 3000 is ended. A service functioning as a backbone of the system that does not rely on the logged-in user is operated in the system session 3200, and a spooler 3201 is operated as a service of the printing-related processing. The spooler 3201 accepts drawing data and print setting information from the desktop applications 3111 and the touch panel applications 3121. A graphics driver 3202 corresponding to the printer 102 at the output destination the printer 102 then generates print data (PDL) on the basis of the drawing data and the print setting information. After that, the spooler 3201 transmits the generated print data (PDL) to the printer 102 via the network 103, and as a result, the printing is executed in the printer 102.

The graphics driver 3202 and the input unit 3112 for the desktop UI surrounded by a dotted line 3300 are provided as a printer driver by a hardware vendor that develops the printer 102. For example, a printer driver is incorporated in the OS 3000 at the time of the installment of the printer 102.

In addition, the input unit 3122 for the touch panel UI is developed and provided by a hardware vendor that develops the printer 102 as an application that provides the print setting UI corresponding to the printer driver in the touch panel UI environment. The input unit 3122 for the touch panel UI is a type of the application operating on the touch panel UI environment 3120. An application group operating on the touch panel UI environment 3120 is managed on an external server for the security and the enhancement in the quality. The application is provided to the client computer 101 by being distributed from an external server via the network 103. The input unit 3122 for the touch panel UI is automatically downloaded to the client computer 101 and incorporated in the system in conjunction with the installment of the printer driver 3300.

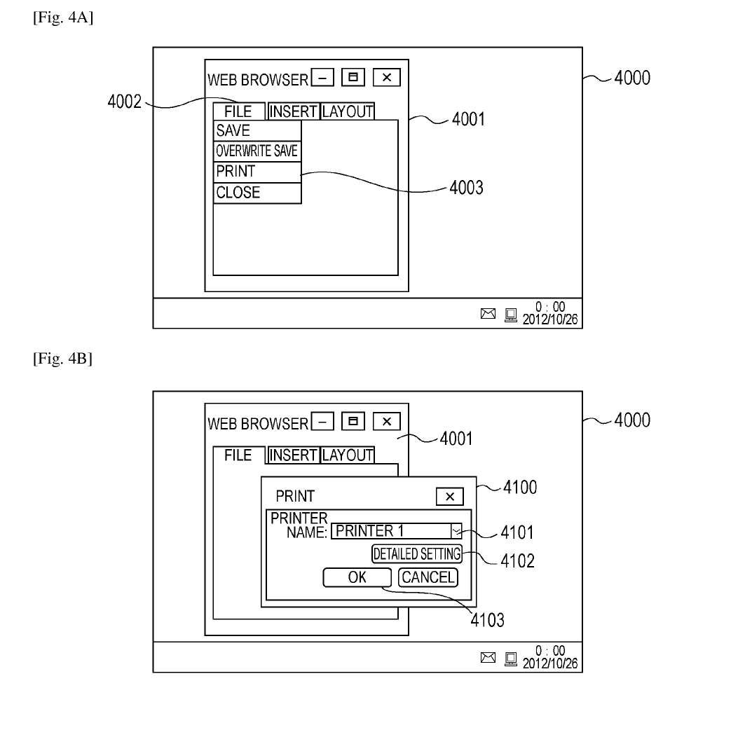

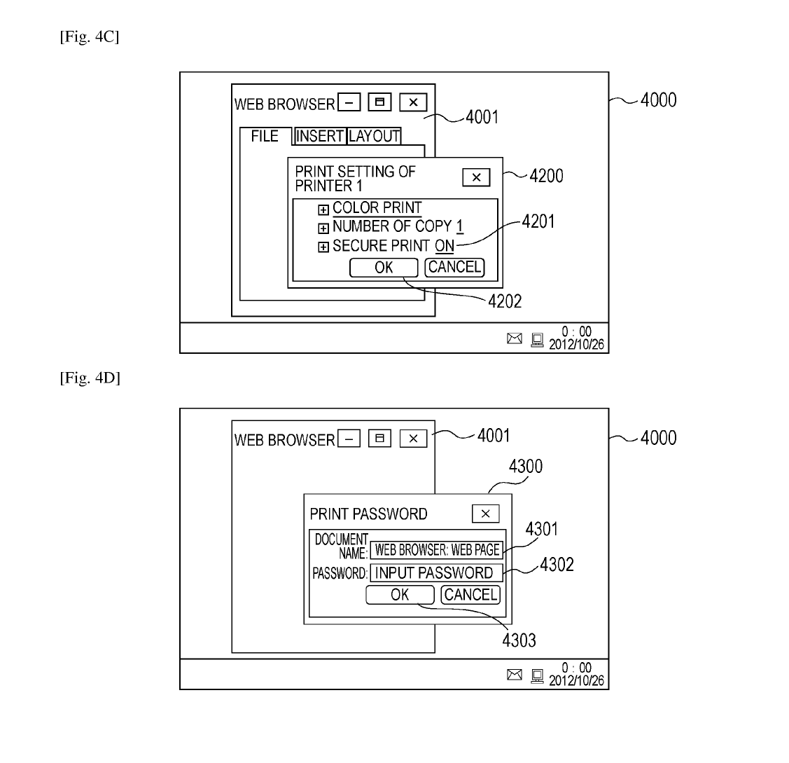

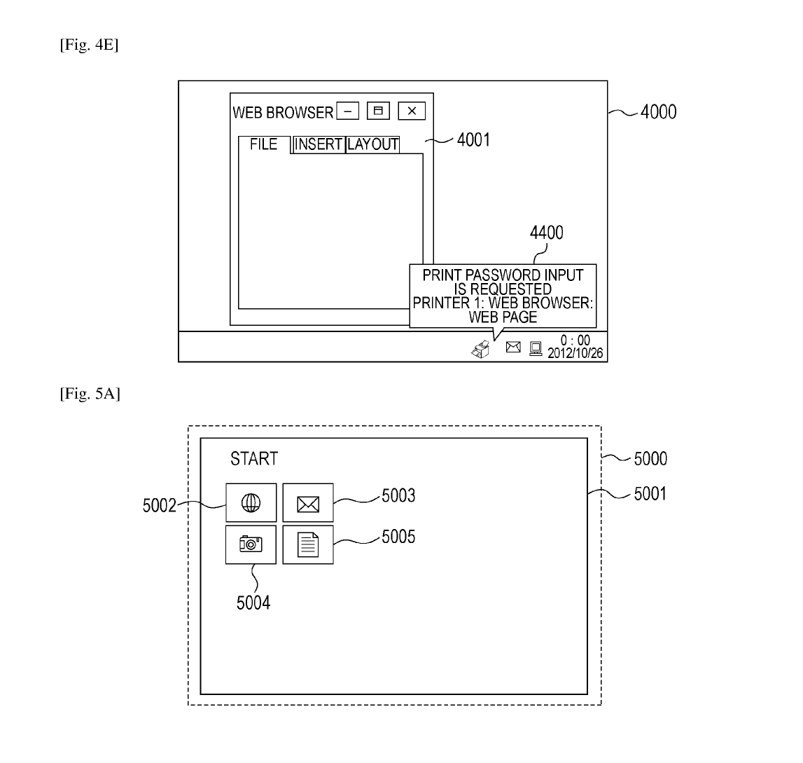

FIGS. 4A to 4E are schematic diagrams of screens in the desktop UI environment 3110 displayed on the touch display 210. A description will be given of a basic UI operation flow of the printing from the desktop application 3111 by using these schematic diagrams.

As illustrated in FIG. 3, the desktop application 3111 is operated on the desktop UI environment 3110. FIG. 4A illustrates an example in which the desktop application 3111 is displayed on the desktop UI environment 3110. A display space called desktop 4000 on the touch display 210 is displayed on the entire desktop UI environment 3110. The desktop application 3111 is displayed in a unique area called window 4001 for the desktop application. Since a menu and the like of the desktop application are displayed in the individual window 4001, it is possible to display the plural desktop applications 3111 at the same time on the desktop 4000. Display contents of the application and menus (4002 and 4003) for the operations are displayed on the window 4001. The desktop application 3111 accepts an input from the touch display 210 or the operation input apparatus 209 and operates. In a case where the printing is conducted from the desktop application 3111, the desktop application 3111 displays a printing dialog 4100 illustrated in FIG. 4B in response to the selection of the print item 4003 of the file menu 4002. A printer name button 4101 for selecting a printer at the output destination, a detailed setting button 4102 for performing a detailed setting on the printer with respect to the selected printer, and a print button 4103 for accepting a printing execution are arranged the printing dialog 4100. In response to a selection of a detailed setting button 4102, the desktop application 3111 requests the OS 3000 for the print detailed setting for the selected printer by the printer name button 4101. In response to the request, the OS 3000 displays the print setting UI (print setting screen) of the input unit 3112 for the desktop UI corresponding to the selected printer. FIG. 4C illustrates a print setting UI 4200 of the input unit 3112 for the desktop UI. The input unit 3112 for the desktop UI is a module that performs print setting processing related to the printer 102. The print setting UI 4200 includes a setting item 4201 of the secure printing according to the present embodiment in addition to the setting related to the printing such as the color printing and the number of copy. Hereinafter, a description will be given on the basis of an exemplary case in which the setting item of this secure printing is ON. When an OK button 4202 is pressed, the printing dialog 4100 of FIG. 4B is displayed. Furthermore, in response to a press of an OK button 4103 (that is, when a printing instruction is input), processing of generating print data is executed. The secure printing is an example of the print setting information where information is to be input upon the instruction of the printing execution, and the user is requested to input a password or a user name.

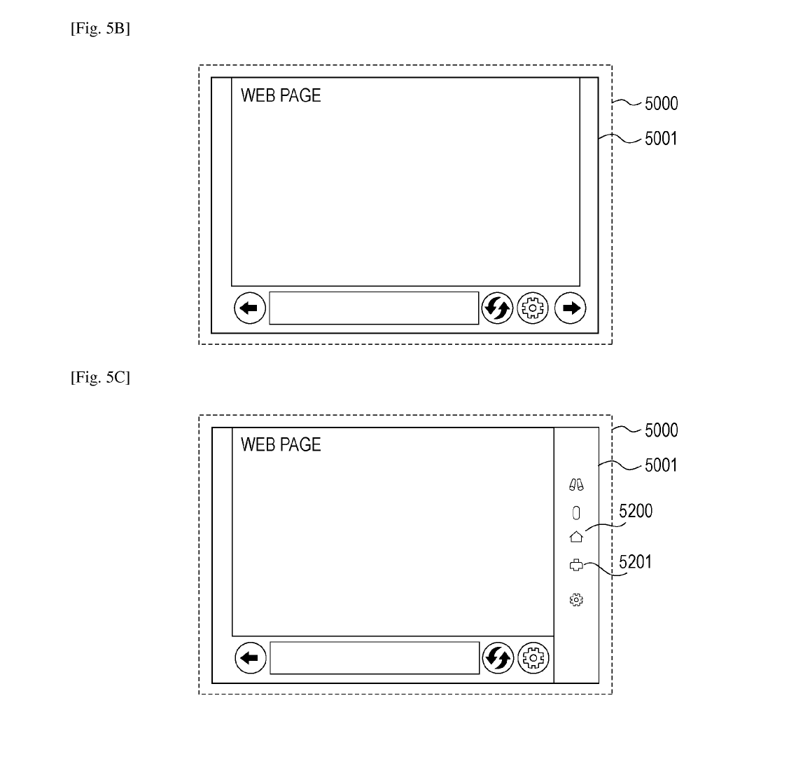

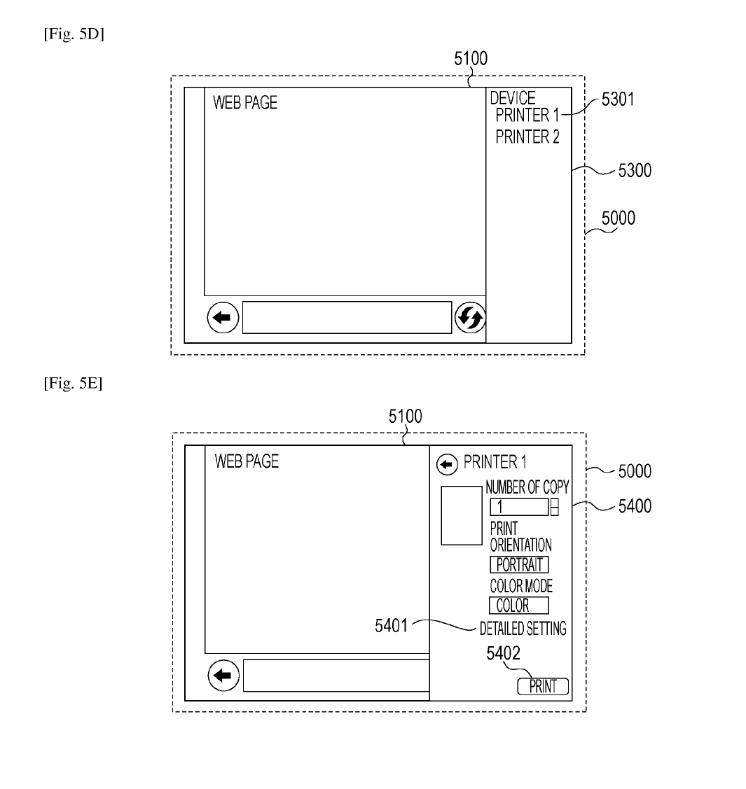

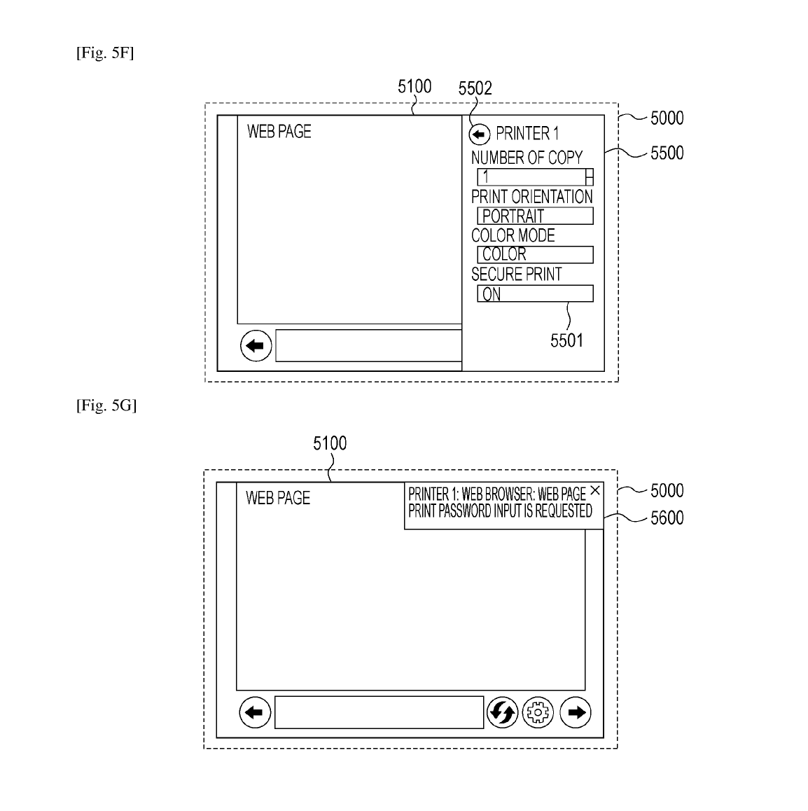

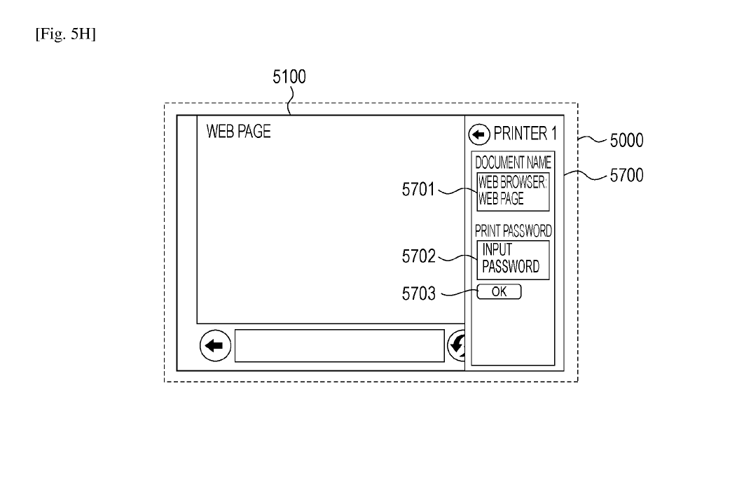

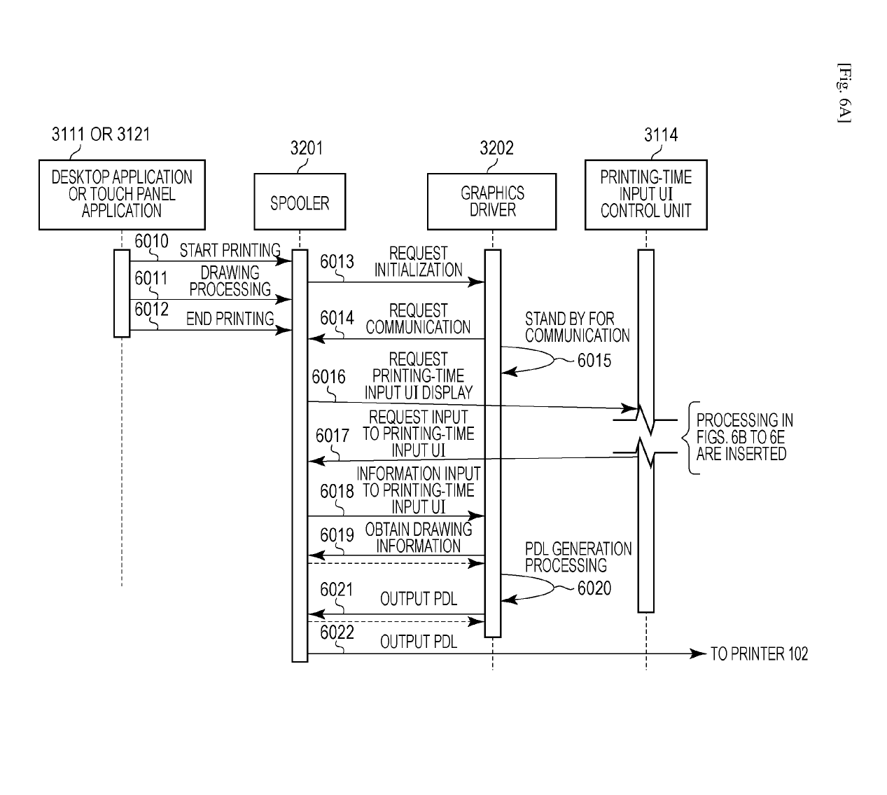

FIGS. 5A to 5H are schematic diagrams of the touch panel UI environment 3120 displayed on the touch display 210. A description will be given of a basic UI operation flow of the printing from the touch panel application 3121 by using these schematic diagrams.

The touch panel UI environment 3120 is a design of the UI with a focus on the operation in the touch display 210. An operation menu is composed of a larger button as compared with a button provided in the desktop UI environment so that the operation through a touching by a finger, a pen, or the like is facilitated. The input of the operation input apparatus 209 such as the mouse or the key board is also accepted in the touch panel UI environment 3120, but the description will be given below on the basis of the operation of the touch display 210. As illustrated in FIG. 3, the touch panel application (the touch panel application) 3121 is operated on the touch panel UI environment 3120. FIG. 5A illustrates a start screen 5001 of the touch panel UI environment 3120. The start screen 5001 is displayed on an entire surface of a touch panel UI 5000. The touch panel applications 3121 of FIG. 3 are displayed in a format of tiles (5002 to 5005) on the start screen 5001. When the user taps a tile, the touch panel application 3121 relevant to the tile is displayed entirely on the touch panel UI 5000. FIG. 5B illustrates a display example of a WEB browser 5100. The WEB browser 5100 is displayed on the entire surface of the touch panel UI 5000, and the other applications are not displayed. In a case where the printing is conducted by the touch panel application 3121, a right edge of the touch display 210 is touched and dragged by a finger, so that a UI menu 5200 for a setting illustrated in FIG. 5C is displayed. While a printing icon 5201 of the UI menu 5200 for the setting is touched, a printer selecting menu 5300 for selecting a printer at the print output destination of FIG. 5D is displayed. Candidates of the print output destination are listed in the printer selecting menu 5300. When a “printer 1” 5301 is tapped among those, a basic print setting UI 5400 provided by the OS 3000 illustrated in FIG. 5E is displayed. The basic print setting information such as the number of copy and the color mode is set in the basic print setting UI 5400. When a detailed setting 5401 is pressed, a print setting UI 5500 of the input unit 3122 for the touch panel UI illustrated in FIG. 5F is displayed. The input unit 3122 for the touch panel UI is a module that performs processing for the print setting for the printer 102. The detailed print setting information related to the printing for the printer 102 can be set in the print setting UI 5500. The print setting UI 5500 includes a setting item 5501 of the secure printing according to the present embodiment in addition to the setting related to the printing such as color printing and multi-copy printing. Hereinafter, a description will be given on the basis of an exemplary case in which this setting is ON. When a “return” button 5502 is pressed, a state returns to a display state of FIG. 5E. Furthermore, in response to a press of a print button 5402 (that is, when the printing instruction is input), processing of generating the print data is executed.

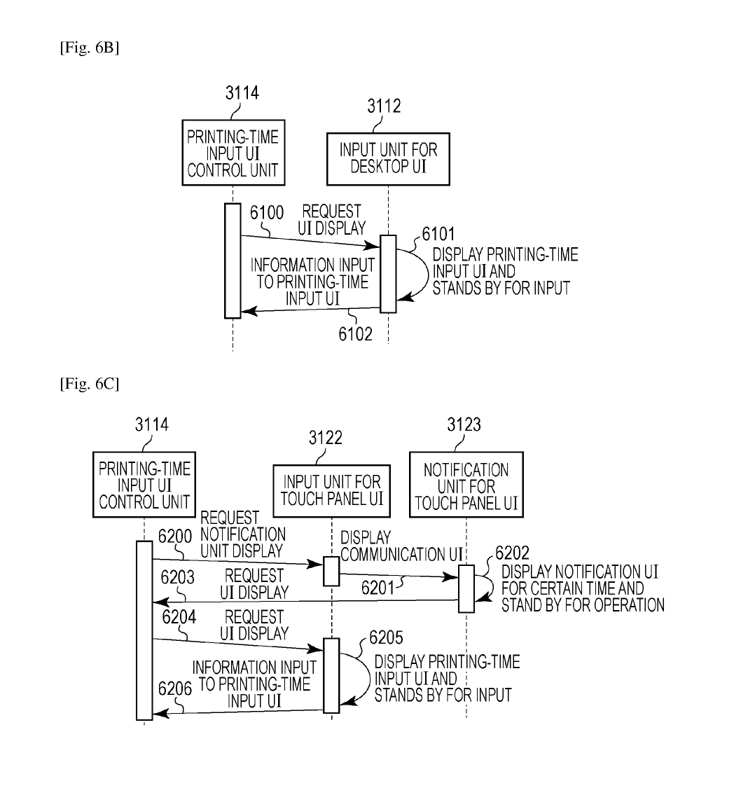

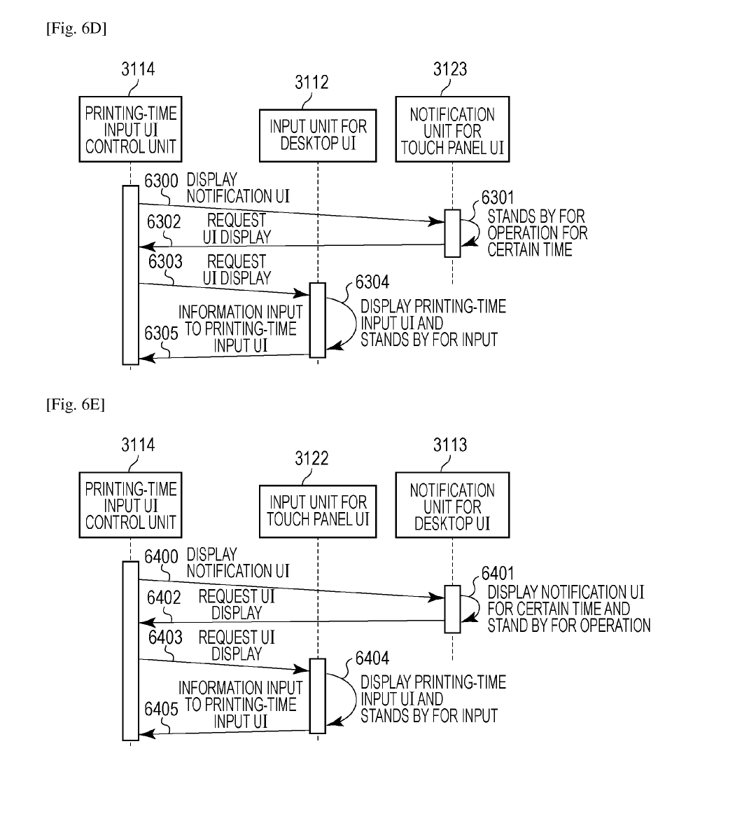

The printing processing after the press of the OK button 4103 of FIG. 4B or the print button 5402 of FIG. 5E in a state in which the print setting information where information is to be input upon the instruction of the printing execution is set like the secure printing will be described by using FIG. 6E. As illustrated in FIG. 6A, the basis sequences for the printing processing of the desktop application and the printing processing of the touch panel application are the same as each other. For that reason, herein, only the printing processing from the desktop application will be described. With regard to the printing processing of the touch panel application, the desktop application may appropriately be replaced in the description by the touch panel application. The printing processing is started in response to the press of the OK button 4103 of FIG. 4B.

The desktop application 3111 uses the function of the OS 3000 to transmit requests 6010 to 6012 of the printing processing to the spooler 3201. The desktop application 3111 first performs a printing start request 6010. In the printing start request 6010, the following information related to the printing is transmitted to the spooler 3201. Information 1300 of FIG. 13 includes the following examples.

User information 1301: Name of a user who has requested printing and user session number thereof

Application information 1302: Name of an application where the printing has been conducted and type thereof (desktop or touch panel)

Document information 1303: Name of a document generated by the application

Printer information 1304: Printer name at the print output destination

Print setting information 1305: Print setting information set by the print setting UIs 4200 and 5500

These pieces of information are transmitted from the spooler 3201 to the printing-time input UI control unit 3114 as additional information of the request. Similarly, these pieces of information are transmitted to the input unit 3112 for the desktop UI, the notification unit 3113 for the desktop UI, the input unit 3122 for the touch panel UI, and the notification unit 3123 for the touch panel UI by the printing-time input UI control unit 3114 as the additional information of the request.

Subsequently, the desktop application 3111 performs a drawing request 6011 to transmit contents to be printed (drawing data). An XML Paper Specification (XPS) format stream is use for a data format for transmitting the contents to be printed. After that, a printing end request 6012 is executed to indicate that all the print contents have been transmitted.

In response to the printing start request 6010, the spooler 3201 outputs an initialization request 6013 to the graphics driver 3202 corresponding to the printer 102 at the output destination on the basis of the printer information 1304. The graphics driver 3202 analyzes the print setting information transmitted as a part of the initialization request. In a case where the secure printing is ON, a communication request 6014 is output to the spooler 3201. A notification message 1310 displayed on the notification message is transmitted as the communication request 6014 in addition to the information 1300 related to the printing of FIG. 13. After that, the graphics driver 3202 is in a stand-by state to wait for information input in the printing-time input user interface (for example, a password) (6015). In response to the communication request 6014, the spooler 3201 outputs a display request 6016 of the printing-time input user interface to the printing-time input UI control unit 3114. In response to that request, the printing-time input UI control unit 3114 performs control processing for displaying the printing-time input user interface.

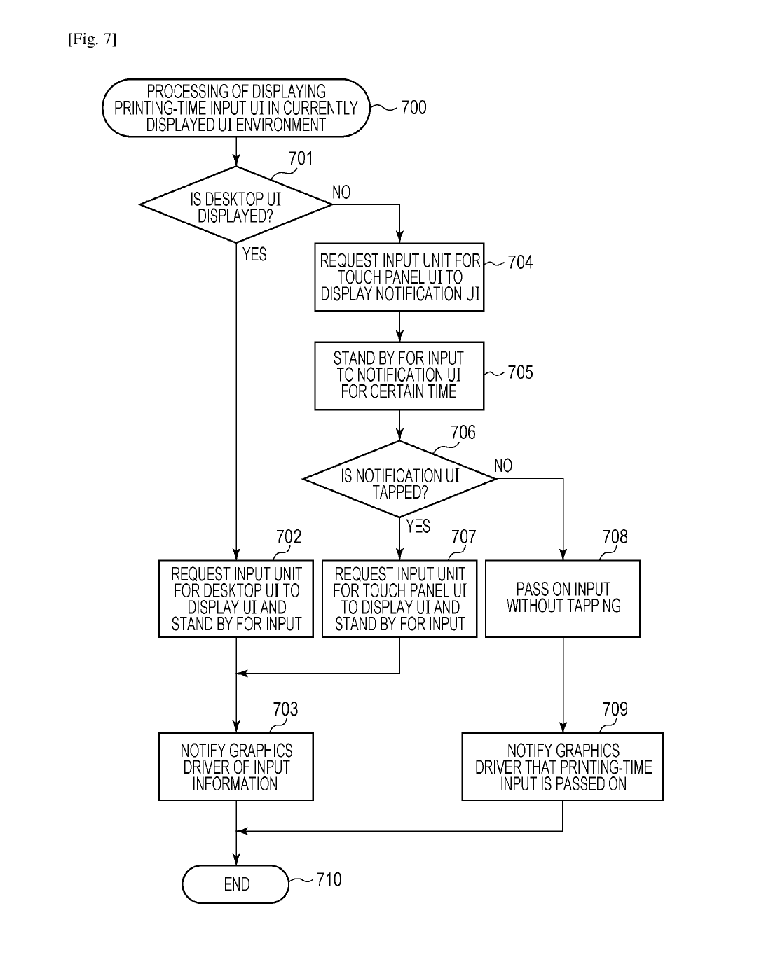

Plural types of the processing sequence for displaying the printing-time input user interface exist as illustrated in FIGS. 6B to 6E. Processing according to the first embodiment will be described below by using a flow chart of FIG. 7.

In a case where the user input the information in the printing-time input user interface, the printing-time input UI control unit 3114 notifies the spooler 3201 of the information input in the printing-time input user interface (6017). The spooler 3201 notifies the graphics driver 3202 of the information input in the printing-time input user interface (6018). Through processing of 6018, the graphics driver 3202 returns from the communication waiting state. The graphics driver 3202 obtains the drawing data from the spooler 3201 (6019) and uses the information input in the printing-time input user interface, the print setting information, and the drawing data to generate print data (PDL) corresponding to a printing command (6020). The graphics driver 3202 outputs the generated print data (PDL) to the spooler 3201 (6021). The spooler 3201 transmits the print data (PDL) to the printer 102 by using the function of the OS 3000.

According to the first embodiment, to avoid the increase in the load of the UI environment switching operation by the user, the printing-time input user interface is displayed in the currently displayed UI environment. FIG. 7 illustrates a processing flow 700 for displaying the printing-time input user interface according to the first embodiment. The operation main constituent of this flow chart is the printing-time input UI control unit 3114 corresponding to one of the OS modules. The processing flow of FIG. 7 is executed in a case where the printing instruction is input (a case where the print button 4103 of FIGS. 4A to 4E or the print button 5402 of FIGS. 5A to 5H is pressed) in a state in which the print setting information where information is to be input upon the instruction of the printing execution is set like the secure printing. The flow chart of this application is realized while the CPU 201 reads out and executes the program associated with the flow chart.

The printing-time input UI control unit 3114 determines the UI environment currently presented to the user on the touch display 210 (701). If the desktop UI 4000 is displayed on the touch display 210, the printing-time input UI control unit 3114 requests the input unit 3112 for the desktop UI to output the printing-time input user interface 4300. After that, until the user inputs the information to the printing-time input user interface 4300 of the input unit 3112 for the desktop UI, the printing-time input UI control unit 3114 stands by for the processing (702).

As illustrated in the sequence of FIG. 6B, the input unit 3112 for the desktop UI that has received a UI display request 6100 displays the printing-time input user interface 4300 on the desktop UI 4000 and stands by for an input (6101). FIG. 4D illustrates the printing-time input user interface 4300 for the desktop UI environment 3110. A document name input field 4301 with which it is possible to identify a target of the secure printing, a password input field 4302 where a password for the secure printing can be input, and an OK button 4303 are arranged in the printing-time input user interface 4300. The OK button 4303 is pressed after the information is input to these items, and the printing-time input user interface 4300 is closed.

The input unit 3112 for the desktop UI notifies the printing-time input UI control unit 3114 of the information input in the printing-time input user interface 4300 (6102). The printing-time input UI control unit 3114 notifies the graphics driver 3202 of the information input to the printing-time input user interface 4300 (703). After that, the processing is ended (710). According to this, the graphics driver 3202 generates the print data based on the information input to the printing-time input user interface 4300. To elaborate, in a case where the OK button 4303 of the printing-time input user interface 4300 is pressed, the print data based on the information input to the printing-time input user interface 4300 is generated.

If the touch panel UI 5000 is displayed on the touch display 210, the printing-time input UI control unit 3114 requests the input unit 3122 for the touch panel UI for a display of a notification UI 5600 (704) and stands by for an input to the notification UI 5600 for a certain time (705). As illustrated in the sequence diagram of FIG. 6C, in response to a notification UI display request 6200, the input unit 3122 for the touch panel UI outputs a request of the display of the notification UI 5600 to the notification unit 3123 for the touch panel UI (6201). The request includes the printer information, the document information, and the texts of the message corresponding to the contents displayed in the notification UI 5600. In addition, a name of the module desired to be opened when the notification UI 5600 is tapped is further described. According to this embodiment, the input unit 3122 for the touch panel UI is specified. The notification unit 3123 for the touch panel UI displays the notification UI 5600 (which is also referred to as toast) of the notification unit 3123 for the touch panel UI illustrated in FIG. 5G on the touch panel UI 5000 (6202). Before the printing-time input user interface 5700 is displayed, the notification unit 3123 for the touch panel UI displays the notification UI 5600 for temporarily displaying the printing-time input user interface on the touch panel UI 5000. This is because a disturbance on the user operation to the application displayed on the touch panel UI 5000 is avoided. The user can appropriately switch the display and non-display of the printing-time input user interface. The notification UI 5600 is displayed on the touch panel UI 5000 for a certain time. When the notification UI 5600 is tapped within the certain time, the notification unit 3123 for the touch panel UI informs the printing-time input UI control unit 3114 of the situation where the tap has been conducted as well as the name of the module desired to be opened when the tap has been conducted (6203). In a case where the notification UI 5600 is not tapped within the certain time, the notification UI 5600 disappears from the touch panel UI 5000. The printing-time input UI control unit 3114 determines whether or not the notification UI 5600 of the notification unit 3123 for the touch panel UI is tapped for a certain time with a certain time (706). If the notification UI 5600 is tapped, the input unit 3122 for the touch panel UI is requested to display the printing-time input user interface 5700 corresponding to the input unit at the time of the printing instruction, and an input to the printing-time input user interface 5700 is waited for (707).

As illustrated in the sequence diagram of FIG. 6C, in response to this UI display request 6204, the input unit 3122 for the touch panel UI displays the printing-time input user interface 5700 on the touch panel UI environment 3120 (6205). FIG. 5H illustrates the printing-time input user interface 5700 for the touch panel UI environment 3120. An input field 5701 for a name of the document with which the target of the secure printing can be identified, a password input field 5702 where a password of the secure printing can be input, and an OK button 5703 are arranged in the printing-time input user interface 5700. The printing-time input user interface 5700 is closed in response to the press of the OK button 5703 after the information is input to these items. The input unit 3122 for the touch panel UI notifies the printing-time input UI control unit 3114 of the information input in the printing-time input user interface 5700 (6206). The printing-time input UI control unit 3114 notifies the graphics driver 3202 of the information input to the printing-time input user interface 5700 (703). After that, the processing is ended (710). According to this, the graphics driver 3202 generates the print data based on the information input to the printing-time input user interface 5700. To elaborate, in a case where the OK button 5703 of the printing-time input user interface 5700 is pressed, the print data based on the information input to the printing-time input user interface 5700 is generated.

If the notification UI 5600 is not tapped within the certain time (708), the graphics driver 3202 is notified of a situation in which the user passes on the input to the printing-time input user interface (709). After that, the processing is ended (710). In a case where the user passes on the input to the printing-time input user interface, the graphics driver 3202 uses default information (for example, a password) previously set by the user to generate the print data (PDL).

As described above, according to the first embodiment, the currently displayed UI environment is determined, and the printing-time input user interface is displayed in the currently displayed UI environment. For example, immediately after the printing instruction is input while the user presses the OK button 4103 of the printing dialog 4100 in the desktop application 3111, the user changes the UI environment from the desktop UI environment 3110 to the touch panel UI environment 3120. In this manner, even in a case where the UI environment is changed after the printing instruction is input, the printing-time input user interface 5700 is displayed in the currently displayed UI environment (the touch panel UI environment 3120 in the above-described example) by using the present first embodiment. On the other hand, immediately after the printing instruction is pressed while the user presses the print button 5402 of the printing dialog 5400 in the touch panel application 3121, the user changes the UI environment from the touch panel UI environment 3120 to the desktop UI environment 3110. In this manner, even in a case where the UI environment is changed after the printing instruction is input, the printing-time input user interface 4300 is displayed in the currently displayed UI environment (the desktop UI environment 3110 in the above-described example) by using the present first embodiment. As a result, the user can input the information used at the time of the printing execution without the UI environment switching operation, and it is possible to avoid the degradation in the operability.

According to the present embodiment, the printing-time input user interface 5700 is displayed since the notification UI 5600 is operated, but the printing-time input user interface 5700 may be displayed in the currently displayed UI environment without the operation of the notification UI. To elaborate, step 707 may be executed following step 701.

### Second Embodiment

According to the first embodiment, the currently displayed UI environment is determined, and the printing-time input user interface is displayed. In a case where the user switches the UI environment after the printing instruction is input according to the first embodiment, the printing-time input user interface is displayed in an environment different from the UI environment where the printing is conducted. For that reason, a problem exists that the user does not understand that the displayed printing-time input user interface is a printing-time input user interface corresponding to which printing, and the user is confused. The processing for solving the above-described problem will be described as a second embodiment.

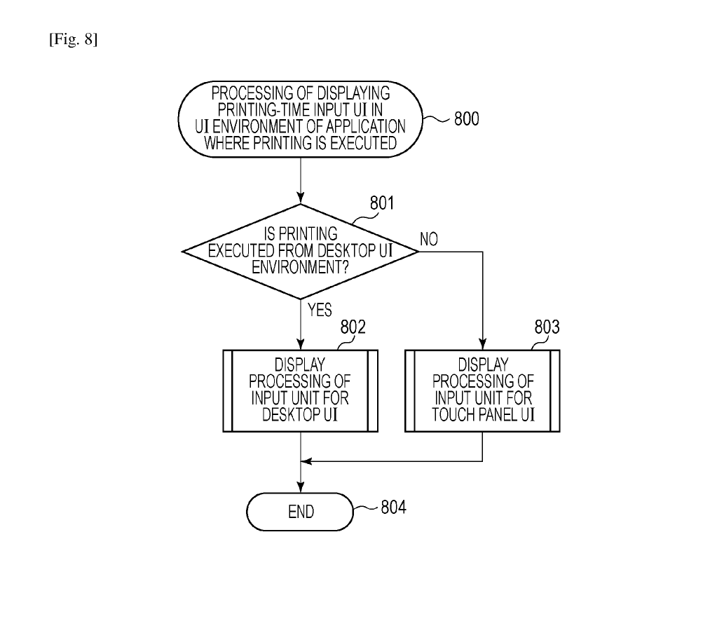

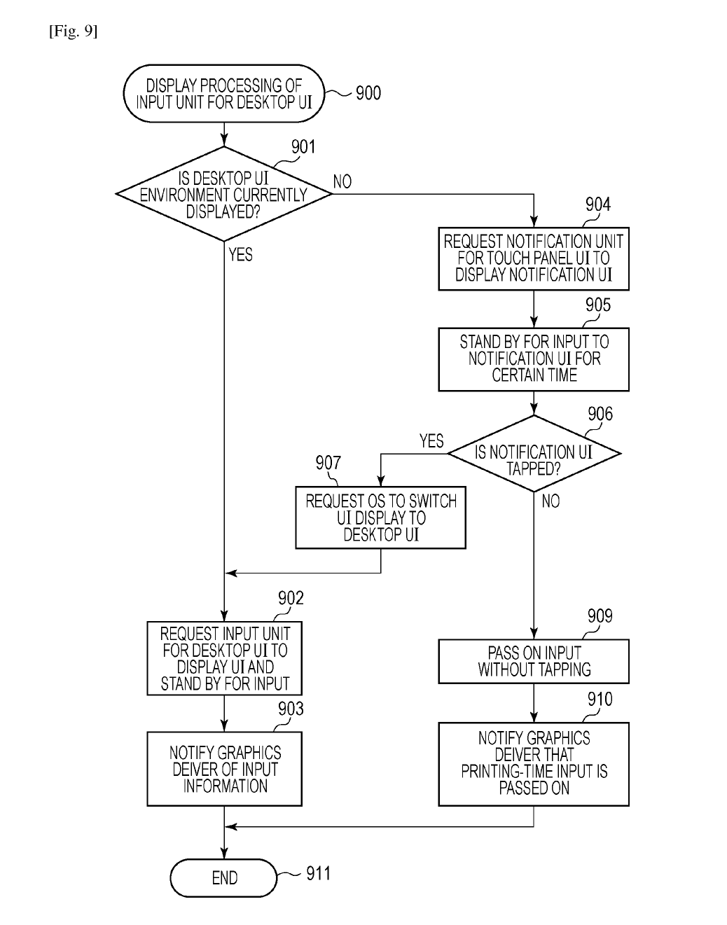

FIG. 8 illustrates a processing flow 800 for displaying the printing-time input user interface in the UI environment of the application where the printing execution is instructed. The operation main constituent of this flow chart is the printing-time input UI control unit 3114. In the system according to the first embodiment, the execution is conducted through the replacement with the processing sequence for displaying the printing-time input user interface of FIG. 7. The processing flow of FIG. 8 is executed in a case where the printing execution is instructed is instructed (a case where the print button 4103 of FIGS. 4A to 4E or the print button 5402 of FIGS. 5A to 5H is pressed) in a state in which the print setting information where information is to be input upon the instruction of the printing execution (for example, the secure printing) is set.

The printing-time input UI control unit 3114 refers to the application information 1302 of the information 1300 related to the printing received from the spooler 3201 and determines by which one of the applications of the UI environments the printing is executed (801).

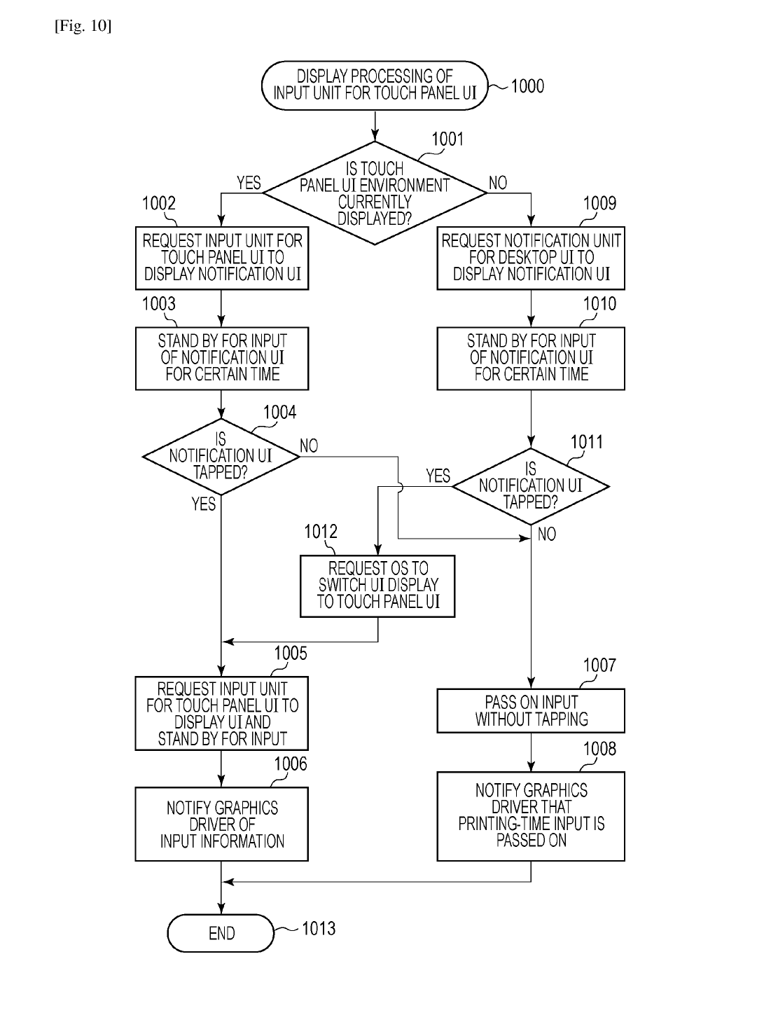

If the printing instruction is input by the desktop application 3111, the printing-time input UI control unit 3114 executes the display processing of the input unit for the desktop UI (802). After that, the processing is ended (804). If the printing instruction is input by the touch panel application 3121, the printing-time input UI control unit 3114 executes the display processing of the input unit for the touch panel UI (803). After that, the processing is ended (804). The display processing of the input unit for the desktop UI and the display processing of the input unit for the touch panel UI will be described by using FIG. 9 and FIG. 10.

FIG. 9 illustrates a display processing 900 of the input unit for the desktop UI. The printing-time input UI control unit 3114 determines which one of the UI environments is currently displayed on the touch display 210 for the user (901).

If the desktop UI 4000 is displayed on the touch display 210, 902 and 903 are executed. These processings are similar processing to 702 and 703 described according to the first embodiment, and a detailed description will be omitted.

If the touch panel UI 5000 is displayed on the touch display 210, the printing-time input UI control unit 3114 requests the notification unit 3123 for the touch panel UI for the display of the notification UI 5600 (904) and waits for an input to the notification UI 5600 for a certain time (905). The above-described request includes the printer information, the document information, and the texts of the message corresponding to the contents displayed in the notification UI 5600. In addition, a name of the module desired to be opened when the notification UI 5600 is tapped is further described. According to this embodiment, the input unit 3112 for the desktop UI is specified. As illustrated in the sequence diagram of FIG. 6D, in response to this display request 6300 of the notification UI, the notification unit 3123 for the touch panel UI displays the notification UI 5600 of the notification unit 3123 for the touch panel UI illustrated in FIG. 5G on the touch panel UI 5000 (6301). Before the printing-time input user interface 5700 is displayed, the notification unit 3123 for the touch panel UI displays the notification UI 5600 for selecting a display of the printing-time input user interface 5700 on the touch panel UI 5000. This is because a disturbance on the user operation to the application displayed on the touch panel UI 5000 is avoided. Since the user taps the notification UI 5600, the user can appropriately switch the display and non-display of the printing-time input user interface 5700. The notification UI 5600 is displayed on the touch panel UI 5000 for a certain time. When the notification UI 5600 is tapped within the certain time, the notification unit 3123 for the touch panel UI informs the printing-time input UI control unit 3114 of the situation where the tap has been conducted as well as the name of the module desired to be opened when the tap has been conducted (6302). If the notification UI 5600 is not tapped within the certain time, the notification UI 5600 disappears from the touch panel UI 5000. The printing-time input UI control unit 3114 determines whether or not the notification UI 5600 of the notification unit 3123 for the touch panel UI is tapped within a certain time (906). If the notification UI 5600 is tapped, the printing-time input UI control unit 3114 switches the UI environment displayed on the touch display 210 to the desktop UI 4000 (907). After that, the input unit 3112 for the desktop UI is requested to display the printing-time input user interface 4300 corresponding to the printing-time input unit, and the input to the printing-time input user interface 4300 is waited for (902). As illustrated in the sequence diagram of FIG. 6D, in response to this UI display request 6303, the input unit 3112 for the desktop UI displays the printing-time input user interface 4300 in the desktop UI environment (6304). The input unit 3112 for the desktop UI notifies the printing-time input UI control unit 3114 of the information input in the printing-time input user interface 4300 (6305). The printing-time input UI control unit 3114 receives and notifies the graphics driver 3202 of the information input in the printing-time input user interface (903), and the processing is ended (911). According to this, a graphics driver 3203 generates the print data based on the information input to the printing-time input user interface 4300.

If the notification UI 5600 is not tapped, the printing-time input UI control unit 3114 recognizes that the user passes on the input to the printing-time input user interface 4300 and notifies the graphics driver 3202 that the input is passed on (910), and the processing is ended (911). In a case where the user passes on the input to the printing-time input user interface 4300, the graphics driver 3202 generates the print data (PDL) by using default information (for example, a password) previously set by the user.

FIG. 10 illustrates a display processing 1000 of the input unit for the touch panel UI.

The printing-time input UI control unit 3114 determines which one of the UI environments is currently displayed on the touch display 210 for the user the user (1001).

If the touch panel UI 5000 is displayed on the touch display 210, the process is conducted in 1002 to 1006 or 1002 to 1004, and 1007 to 1008, and the processing is ended (1013). These processings are similar processing to 704 to 703 and 704 to 709 described according to the first embodiment, and a detailed description will be omitted.

In a case where the desktop UI 4000 is displayed on the touch display 210, the printing-time input UI control unit 3114 requests the notification unit 3113 for the desktop UI to display a notification UI 4400 (which is also referred to as balloon) (1009). The printing-time input UI control unit 3114 then waits for an input to the notification UI 4400 for a certain time (1010). The above-described is a sequence of 6400 in the sequence diagram of FIG. 6E. This request includes the printer information, the document information, and the texts of the message corresponding to the contents displayed in the notification UI 4400. In addition, a name of the module desired to be opened when the notification UI 4400 is tapped is further described. Herein, the input unit 3122 for the touch panel UI is specified. The notification unit 3113 for the desktop UI displays the notification UI 4400 of the notification unit 3113 for the desktop UI illustrated in FIG. 4D on the desktop UI 4000 (6401). The notification UI 4400 is displayed on the desktop UI 4000 for a certain time. When the notification UI 4400 is tapped within the certain time, the notification unit 3113 for the desktop UI informs the printing-time input UI control unit 3114 of the situation where the tap has been conducted as well as the name of the module desired to be opened when the tap has been conducted (6402). If the notification UI 4400 is not tapped within the certain time, the notification UI 4400 disappears from the desktop UI 4000. The printing-time input UI control unit 3114 determines whether or not the notification UI 4400 of the notification unit 3113 for the desktop UI is tapped within a certain time (1011). If the notification UI 4400 is tapped, the printing-time input UI control unit 3114 instructs to switch the UI environment displayed on the touch display 210 from the desktop UI 4000 to the touch panel UI 5000 (1012). After that, the printing-time input UI control unit 3114 requests the input unit 3122 for the touch panel UI to display the printing-time input user interface 5700 corresponding to the printing-time input unit and waits for an input to the printing-time input user interface 5700 (1005). As illustrated in the sequence diagram of FIG. 6E, in response to this UI display request 6403, the input unit 3122 for the touch panel UI displays the printing-time input user interface 5700 in the touch panel UI environment (6404). The input unit 3122 for the touch panel UI notifies the printing-time input UI control unit 3114 of the information input in the printing-time input user interface 5700 (6405). The printing-time input UI control unit 3114 notifies the graphics driver 3202 of the information input in the printing-time input user interface (1006), and the processing is ended (1013). According to this, the graphics driver 3203 generates the print data based on the information input to the printing-time input user interface 5700.

If the notification UI 4400 is not tapped (1007), the printing-time input UI control unit 3114 informs the graphics driver 3202 that the user passes on the input to the printing-time input user interface 5700 occur (1008), and the processing is ended (1013).

As described above, according to the second embodiment, since the printing-time input user interface is displayed in the UI environment of the application where the printing instruction is input, it is possible to input the information used for the printing execution in the UI environment where the printing instruction is input.

In a case where the UI environment different from the application where the printing instruction is input is displayed on the touch display 210, the notification UI is displayed before the printing-time input user interface is displayed. Since the notification UI is displayed, the user can select whether to conduct the input while being away from the current UI environment.

### Third Embodiment

An OS that can exclusively provide the desktop UI environment and the touch panel UI environment is also operated on the portal device 104 of FIG. 1. The hardware configuration of the portal device 104 is also the configuration illustrated in FIG. 2. It is noted that the portal device 104 is often used in a state in which the operation input apparatus 209 such as the key board or the mouse is not mounted to the operation input apparatus I/F 205 in consideration of easy carrying. In that case, the user operates the portal device 104 by using touching on the touch display 210 by a finger instead of the mouse. With regard to the key board operation, a soft key board and an operation area where handwriting is recognized are displayed on the touch display 210, and the key board is operated by using those.

The desktop UI environment 3110 presupposes the operation by the mouse. For that reason, a problem occurs that it is difficult for the user to perform an input to the screen of the input unit 3112 for the desktop UI in a case where the operation input apparatus 209 is not mounted. To cite an example, since buttons and the like provided in the desktop UI environment 3110 are small, a problem exists that an erroneous operation is likely to occur by the touch operation.

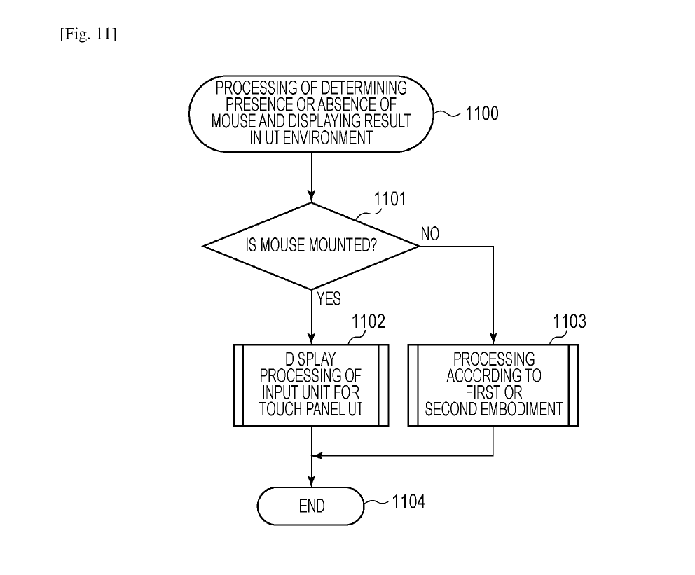

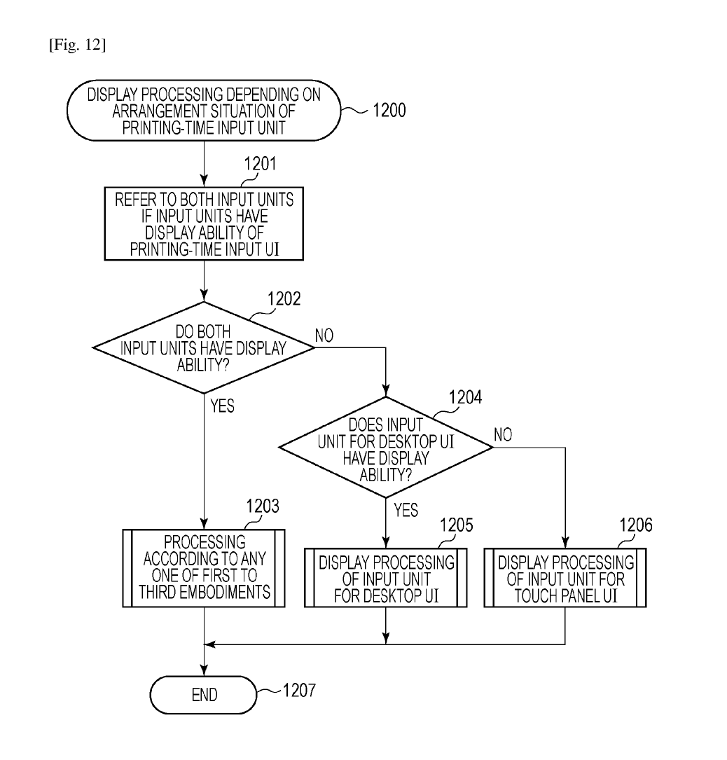

FIG. 11 illustrates a processing flow 1100 for determining the presence or absence of the mouse and displaying the printing-time input user interface. The operation main constituent of this flow chart is the printing-time input UI control unit 3114. In the system according to the first embodiment, the execution is conducted through the replacement with the processing sequence for displaying the printing-time input user interface of FIG. 7.

The printing-time input UI control unit 3114 first determines whether or not the mouse is mounted to the operation input apparatus I/F 205. If the mouse is not mounted, the display processing 1000 of the input unit for the touch panel UI illustrated in FIG. 10 is executed (1102), and the processing is ended (1104). With regard to the display processing 1000 of the input unit for the touch panel UI, the description has already been given in the explanation of the second embodiment, and a detailed description will be omitted.

If the mouse is mounted, the processing according to the first or second embodiment is executed (1103). After that, the processing is ended (1104).

As described above, in a case where the mouse is not mounted, the printing-time input user interface 5700 of the input unit 3122 for the touch panel UI where the operation by way of touching is more facilitated is displayed as the printing-time input user interface. According to this configuration, in a case where the mouse is not mounted, the printing-time input user interface of the input unit 3122 for the touch panel UI where the operation by way of touching is more facilitated is automatically displayed.

### Fourth Embodiment

According to the above-described first to third embodiments, the description has been given by using the environment where the input unit 3122 for the touch panel UI is already incorporated in the OS 3000. The input unit 3122 for the touch panel UI is distributed from the external server via the network 103. For that reason, a case where the input unit 3122 for the touch panel UI is not incorporated in the OS 3000 may also be considered depending on a state of the network. The hardware vendor of the printer 102 may develop and provide only one of the input unit 3112 for the desktop UI and the input unit 3122 for the touch panel UI. As a result, a situation where either the input unit 3112 for the desktop UI or the input unit 3122 for the touch panel UI is not incorporated is also conceivable.

That is, the present embodiment aims at displaying the UI environment where the printing-time input user interface can be displayed.

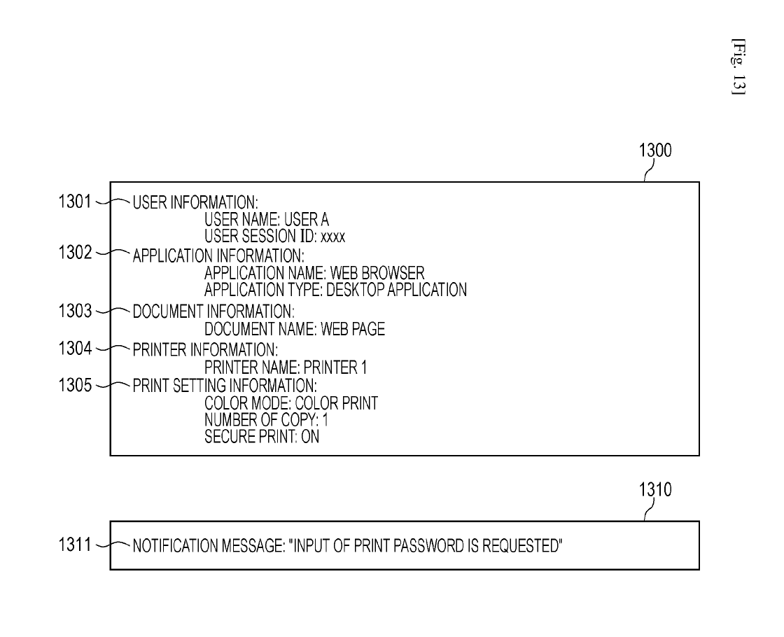

FIG. 12 illustrates a processing flow 1200 according to the present fourth embodiment. The operation main constituent of this flow chart is the printing-time input UI control unit 3114. In the system according to the first embodiment, the execution is conducted through the replacement with the processing sequence for displaying the printing-time input user interface of FIG. 7.

The printing-time input UI control unit 3114 first checks whether or not the display ability of the printing-time input user interfaces 4300 and 5700 exists with respect to the input unit 3112 for the desktop UI and the input unit 3122 for the touch panel UI (1201). Specifically, with regard to the input unit 3112 for the desktop UI, the processing in 1201 is realized by determining whether or not the ability of displaying the printing-time input user interface 4300 exists. On the other hand, the processing in 1201 is realized by determining whether or not the input unit 3122 for the touch panel UI is already installed. In a case where the display ability of the both printing-time input user interfaces exists (Yes in 1202), the printing-time input UI control unit 3114 advances the process to 1203 and performs the processing according to any one of the above-described first to third embodiments.

In a case where the display ability of one of the printing-time input user interfaces does not exist (No in 1202, the processing of the printing-time input UI control unit 3114 progresses to 1204. In a case where the input unit 3112 for the desktop UI is provided with the display ability of the printing-time input user interface 4300 (Yes in 1204), the printing-time input UI control unit 3114 advances the processing to 1205. In 1205, the display processing 900 of the input unit for the desktop UI illustrated in FIG. 9 is executed. In a case where the input unit 3112 for the desktop UI is not provided with the display ability of the printing-time input user interface 4300 (No in 1204), the printing-time input UI control unit 3114 advances the processing to 1206. In 1206, the display processing 1000 of the input unit for the touch panel UI illustrated in FIG. 10 is executed. The printing-time input UI control unit 3114 displays an error message in a case where the input unit 3112 for the desktop UI is not provided with a function of displaying the printing-time input user interface and also the input unit 3122 for the touch panel UI is not installed.

As described above, even in a case where the display ability of the printing-time input user interface exists for only one of the input unit 3112 for the desktop UI and the input unit 3122 for the touch panel UI as a situation of the system, it is possible to avoid the degradation in the operability of the user.

According to the present embodiment, it is described that the processing in 1202 is realized by determining whether or not the input unit 3122 for the touch panel UI is installed. However, even when the input unit 3122 for the touch panel UI is already installed, in a case where the function of displaying the printing-time input user interface 5700 is not provided, the processing of the printing-time input user interface control unit proceeds from 1202 to 1204.

### Other Embodiments

According to the above-described embodiments, the description has been given on the basis of the “secure printing” where a third party does not look at the printed product. In the case of the printing processing in which the printing-time input user interface is displayed when the printing instruction is input, the configuration may not be limited to the “secure printing”. The configuration can also be realized by a “department management printing” where a counter is managed by each department, a “FAX transmission” where a printing target is transmitted by facsimile (FAX) from the printer, or the like. In a case where the department management printing is set, the printing-time input user interface includes an item for inputting department information. In a case where the FAX transmission is set, the printing-time input user interface includes an item for inputting a FAX number.

According to the above-described embodiments, in a case where the operation to the notification UI is not carried out, once the user passes on the input, the printing-time input UI control unit 3114 informs the graphics driver 3202 that the user passes on the input to the printing-time input user interface (709, 1008). The printing-time input UI control unit 3114 can also prompt the input by displaying the notification UI by plural times at a certain time interval without informing the graphics driver 3202 after the user passes on the input on one occasion, so that the timing for the input can be provided by plural times.

According to the embodiments of the present invention, it is possible to avoid the degradation in the operability the user.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) (Trademark)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-008620, filed Jan. 21, 2013, which is hereby incorporated by reference herein in its entirety.

1. An information processing apparatus comprising:
a determination unit configured to determine, in a case where a printing instruction is output for generating print data via a printing dialog of an application in a first user interface environment, whether a currently presented user interface environment is the first user interface environment or the second user interface environment; and
a display unit configured to display, in a case where the determination unit determines that the currently presented user interface environment is the second user interface environment, a display area where an instruction can be accepted in the second user interface environment, wherein, when the display area is instructed, a printing-time input screen corresponding to the output instruction is displayed in the second user interface environment.

2. The information processing apparatus according to claim 1, wherein the print data is generated on the basis of default information of a printer driver in a case where information is not input via the printing-time input screen.

3. The information processing apparatus according to claim 1, wherein the information input via the printing-time input screen is a password used for secure printing, department information used for department management printing, or a facsimile number used for facsimile transmission.

4. The information processing apparatus according to claim 1, wherein the first user interface environment is provided by a platform for a desktop UI environment, and the second user interface environment is provided by a platform for a touch panel UI environment.

5. A control method comprising:
determining, in a case where a printing instruction is output for generating print data via a printing dialog of an application in a first user interface environment, whether a currently presented user interface environment is the first user interface environment or the second user interface environment; and
displaying, in a case where it is determined that the currently presented user interface environment is the second user interface environment, a display area where an instruction can be accepted in the second user interface environment,
wherein, when the display area is instructed, the printing-time input screen corresponding to the output instruction is displayed in the second user interface environment.

6. The control method according to claim 5, wherein the print data is generated on the basis of default information of a printer driver in a case where information is not input via the printing-time input screen.

7. The control method according to claim 5, wherein the information input via the printing-time input screen is a password used for secure printing, department information used for department management printing, or a facsimile number used for facsimile transmission.

8. The control method according to claim 5, wherein the first user interface environment is provided by a platform for a desktop UI environment, and the second user interface environment is provided by a platform for a touch panel UI environment.

9. A non-transitory recording medium storing a program for causing a computer to execute:
determining, in a case where a printing instruction is output for generating print data via a printing dialog of an application in a first user interface environment, whether a currently presented user interface environment is the first user interface environment or the second user interface environment; and
displaying, in a case where it is determined that the currently presented user interface environment is the second user interface environment, a display area where an instruction can be accepted in the second user interface environment,
wherein, when the display area is instructed, the printing-time input screen corresponding to the output instruction is displayed in the second user interface environment.

10. (canceled)

11. (canceled)

12. (canceled)
